(19) United States
(12) Patent Application Publication
(10) Pub. No.: US 2008/0047774 A1
(43) Pub. Date: Feb. 28, 2008

(54) Power Steering

(75) Inventors: Ronald Bayer, Muhlheim/Main (DE); Christiano Hoffmann, Frankfurt (DE); Johann Jungbecker, Badenheim (DE); Steffen Linkenbach, Eschborn (DE); Joachim Nell, Hanau (DE); Norman Muth, Frankenberg (DE)

Correspondence Address: Craig Hallacher;Continental Teves, Inc., One Continental Drive, Auburn Hills, MI, 48326, US

(73) Assignee: Continental Teves AG & Co. oHG

(21) Appl. No.: 10/584,704

(22) PCT Filed: Dec. 17, 2004
(86) PCT No.: PCT/EP04/53576

§ 371 Date: Jul. 16, 2007

(30) Foreign Application Priority Data
Dec. 24, 2003 (DE) 10361232.7

(51) Int. Cl. B62D 5/00

(52) U.S. Cl. 180/404

(57) ABSTRACT

Disclosed is a transmission lock for a superposition steering system of a motor vehicle. The transmission lock is for locking a rotatable transmission element associated with the transmission or interacting with the transmission with respect to its rotational movement. A clamping element, such as a clamping roller, is used to positively lock, by way of a contour of an inner peripheral surface of an outer ring and a contour of an outer peripheral surface of an inner ring, the inner ring with the outer ring in opposition to an elastic force, and that the clamping roller is retained in an activation cage that can be locked by way of an actuatable locking member.

### BACKGROUND OF THE INVENTION

The present invention relates to a transmission lock for a superposition steering system of a motor vehicle, for locking a rotatable transmission element associated with the transmission or interacting with the transmission with respect to its rotational movement.

The invention likewise relates to a superposition steering system comprising a superposition transmission with a first input for actuation by the driver with the aid of a steering handle, a second input for a superposition actuator, and an exit to the steering transmission of the steering system, by means of which superposition transmission (depending on the driving situation) an output angle and, thus, a wheel angle of the steerable vehicle wheels is adjusted via both inputs, and comprising a locking unit by means of which the second input for the superposition actuator is locked in the event of system failure, and steerability of the vehicle by the driver is maintained.

An additional steering angle can be superposed on the driver's steering angle in a superposition steering system. The result is that free allocation of the steering wheel position and the steer angle is possible. This free allocation is executed e.g. by way of an electromechanical actuator, which is composed of a superposition transmission, a motor, and suitable sensors.

When the system for the superposition function is disabled in the event of a fault, the superposition transmission must be locked in such a fashion that a normal steering function is still possible. Additional locking is required for this system condition.

An object of the invention involves disclosing a locking mechanism, which is appropriate for a superposition steering system.

### SUMMARY OF THE INVENTION

This object is achieved by a transmission lock for a superposition steering system of a motor vehicle, for locking a rotatable transmission element associated with the transmission or interacting with the transmission with respect to its rotational movement, characterized in that a clamping element is used to positively lock, by way of a contour of an inner peripheral surface (inner contour) of an outer ring (2) and a contour of an outer peripheral surface (outer contour) of an inner ring (4), the inner ring (4) with the outer ring (2) in opposition to an elastic force, and that the clamping roller (7) is retained in an activation cage (5) that can be locked by way of an actuatable locking member. The object is also achieved by a superposition steering system including a superposition transmission with a first input for actuation by the driver with the aid of a steering handle, a second input for a superposition actuator, and an exit to the steering transmission of the steering system, by means of which superposition transmission (depending on the driving situation) an output angle and, thus, a wheel angle of the steerable vehicle wheels is adjusted via both inputs, and comprising a locking unit by means of which the second input for the superposition actuator is locked in the event of system failure, and steerability of the vehicle by the driver is maintained.

Accordingly, it is essential to the invention that a clamping element, especially a clamping roller, is used to positively lock, by way of a contour of an inner peripheral surface (inner contour) of an outer ring and a contour of an outer peripheral surface (outer contour) of an inner ring, the inner ring with the outer ring in opposition to an elastic force, and that the clamping roller is retained in an activation cage that can be locked by way of an actuatable locking member.

According to the invention, the clamping element, in the locked position, is urged via a double ramp of the outer ring in opposition to an elastic force, preferably against an elastic force of a lock washer, into a ramp of an inner ring, while the clamping element, in the unlocked position, is urged by an elastic force, preferably the elastic force of a locking washer, into a dome of the double ramp of the outer ring, and the clamping element is spaced from the ramps of the inner ring in the unlocked position.

According to the invention, the activation cage is operatively connected to an activation disc, engaging into the accommodation of which is a locking member part associated with the locking member in a locking position, while it is withdrawn from the accommodation in an unlocked position.

According to the invention, the locking member or the locking member part associated with the locking member is pivoted essentially in parallel to the course of the longitudinal axis of the activation cage.

According to the invention, the locking member includes at least one hinged swivel arm, said swivel arm including at least one engagement part engaging into the accommodation at least in part in order to bring about locking of the transmission.

It is provided by the invention that the accommodation associated with the rotatable transmission element is an axial toothing interacting with the rotatable transmission element and, that the engagement part includes at least one engaging tooth, which gears into the axial toothing at least in part in order to bring about locking of the transmission.

It is provided by the invention that the operable locking member can be actuated by way of an electromagnet and locks the transmission in the deenergized condition of the electromagnet.

The invention designates that the activation cage is centered between the inner ring and the outer ring by way of an elastic means, preferably compression springs.

The invention designates that the elastic means centering the activation cage is used to lock the transmission torque-responsively, because in the event of a torque of the transmission which is higher than a biasing moment of the elastic means, in particular depending on the direction of rotation, the clamping elements will positively lock the inner ring with the outer ring in opposition to the elastic force by way of the contour of the inner peripheral surface of the outer ring and the contour of the outer peripheral surface of the inner ring.

According to the invention, a lock washer is used as a means to generate the elastic force, said lock washer having at least one angled-off portion similar to a torsion spring, which comes into abutment in a groove of the activation cage, for the purpose of positioning and avoiding a radial movement of the lock washer in the activation cage.

The above object is also achieved by a superposition steering system comprising a superposition transmission with a first input for actuation by the driver with the aid of a steering handle, a second input for a superposition actuator, and an exit to the steering transmission of the steering system, by means of which superposition transmission (depending on the driving situation) an output angle and, thus, a wheel angle of the steerable vehicle wheels is adjusted via both inputs, and comprising a locking unit by means of which the second input for the superposition actuator is locked in the event of system failure, and steerability of the vehicle by the driver is maintained, being characterized in that a transmission lock according to the invention is provided as a locking unit.

### BRIEF DESCRIPTION OF THE DRAWINGS

The invention is now explained in detail as an example by way of an embodiment and by illustrations (FIG. 1a to FIG. 2c):

FIG. 1a shows a cross-section taken through a transmission lock of a superposition steering system of the invention in the inactive, unlocked condition;

FIG. 1b is a first perspective view of the transmission lock in the inactive unlocked condition;

FIG. 1c is a second perspective view of the transmission lock in the inactive unlocked condition;

FIG. 2a shows a cross-section through a transmission lock of a superposition steering system in the inactive locked condition;

FIG. 2b is a first perspective view of the transmission lock in the inactive locked condition;

FIG. 2c is a second perspective view of the transmission lock in the inactive locked condition.

### DETAILED DESCRIPTION OF THE DRAWINGS

The transmission lock shown in the drawings is used to lock a superposition transmission of a superposition steering system of a motor vehicle.

The superposition transmission is a gear unit with two inputs: a first input for actuation by a driver with the aid of a steering handle, in particular a steering wheel, and a second input for a superposition actuator, in particular an electric motor (E-motor). The gear unit has an output to the steering gear of the steering system.

When the system is activated, depending on the driving situation, an output angle and, thus, a wheel angle of the steerable vehicle wheels are adjusted via both inputs. In the event of system failure, the second input (E-motor) is locked in order to preserve steerability of the vehicle for the driver. This locking of the transmission is preferably carried out by way of a cutout blade, which is engaged in a locking disc of the locking mechanism in a biased manner. A cage of the superposition transmission is blocked as a result of the locking engagement. The steering ‘gripthrough’, i.e. a direct steering actuation possibility for the driver is maintained this way.

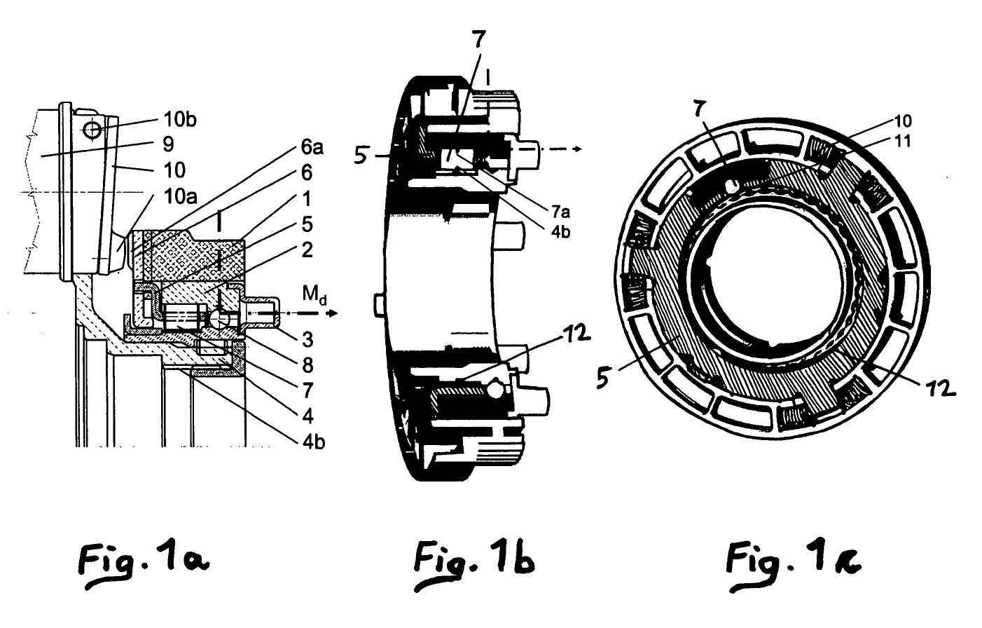

In the transmission lock illustrated in FIGS. 1a to 1c, the superposition transmission is not locked, i.e. the transmission lock is ‘inactive’.

The inner ring (4) is connected to the housing by way of form lock (4c). The clamping elements (7) are urged by a lock washer (12) into the dome of a double ramp (2a) of an outer ring (2), and contact of the clamping elements (7) with calotte (4a) of an inner ring (4) is thus avoided. The unit can freely rotate in both directions of rotation.

An activation cage (5) is centered by way of compression springs (11) which additionally serve for a torque-responsive connection, i.e. locking of the unit. The compression springs (11) are supported on the cage (5) and in spring-accommodating pockets (1a) of a plastic pulley (1) (plastic belt) which is operatively connected to a superposition motor.

The plastic pulley (1) is positively connected to the outer ring (2) for torque transmission. The bias of the compression springs (11) is chosen such that torque transmission in a nominal range takes place from the plastic pulley via the outer ring (2) into the power take-off, i.e. an entrainment means (3), to a superposition transmission. This corresponds to driving by means of a secondary gear, e.g. by way of a toothed belt, and an E-motor as a superposition motor, meaning to the intervention into the superposition transmission, preferably a planetary gear.

In this (active) operating condition, an electromagnet (9) is energized and, in opposition to actuating springs (10c), draws an engaging tooth (10a) of an activation disc (10) out of engagement from an activation lock disc (6) of the locking unit.

The inclined and radial forces are accommodated and the unit is centered by way of a four-point ball bearing (8). This bearing is expediently arranged below the belt guide.

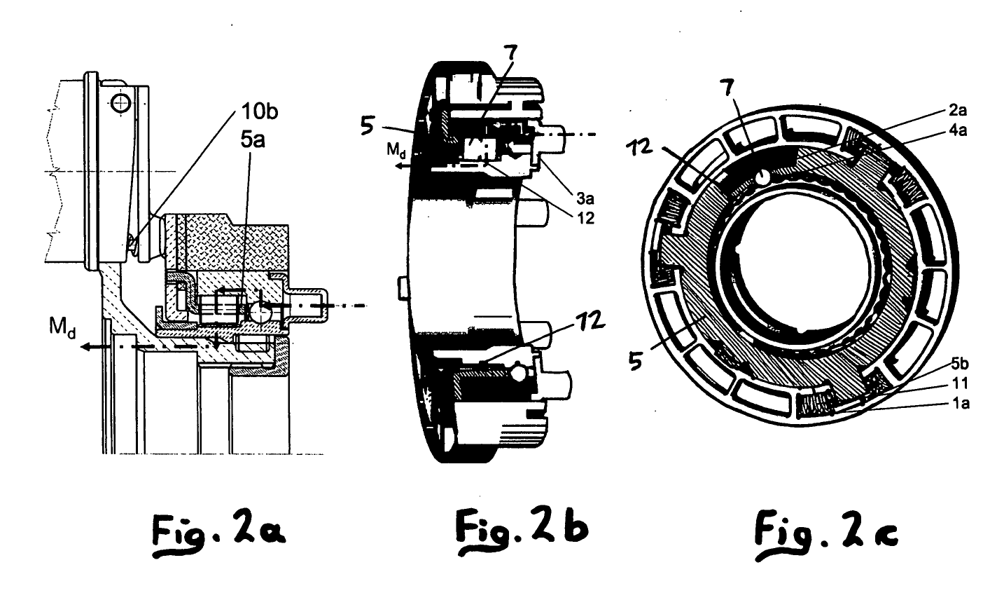

FIGS. 2a to 2c illustrate the situation when a system fault such as current failure occurs. The transmission lock is ‘active’ in this case, i.e. the superposition transmission is locked.

The E-magnet (9) is de-energized in this case and releases the activation disc (10). Assisted by actuating springs (10c), tooth (10a) drops into the activation disc (6) of the locking unit and thereby arrests the activation cage (5).

When a moment, which is higher than the biasing moment of the compression springs (11), is introduced from the (planetary) gear side via the entrainment disc (3), the clamping rollers (7), depending on the direction of rotation, are urged by way of the ramp (2a) of the outer ring (2) against the lock washer (12) into the calottes (4a) of the inner ring (4). As this occurs, the lock washer (12) disappears in a spring groove (4b) of the inner ring (4). Thus, the system is positively locked.

To prevent the lock washer (12) from moving, the lock washer (12) has two angled-off portions similar to a torsion spring. The angled-off portions are placed in a groove of the activation cage (5) and position the spring (12) in a well-defined manner. The length of the springs is dimensioned in such a way that they will not move out of the cage (5) during the actuation and the change in diameter that occurs then.

When the system is energized again, the unit will resume its basic function due to the centering springs (11), as has been described hereinabove.

List of Reference Numerals:
1 plastic pulley with belt guide
1a spring-accommodating pockets
2 outer ring
2a double ramp with controlling function
3 entrainment means/interface with planetary gear
3a slot seal
4 inner ring
4a calotte
4b spring immersion groove
4c form lock to housing seat
5 activation cage
5a cage pocket
5b spring-positioning lug
6 activation locking disc
6a axial toothing
7 clamping element
7a spring-retaining groove
8 four-point ball bearing
9 E-magnet
10 activation disc
10a engaging tooth
10b point of rotation
10c activation spring
11 compression spring for the torque-responsive activation
12 lock washer

1-11. (canceled)

12. A transmission lock for a superposition steering system of a motor vehicle, the transmission lock comprising:
a clamping element having an inner ring and an outer ring, wherein the clamping element is used to positively lock, by way of a contour of an inner peripheral surface (inner contour) of an outer ring (2) and a contour of an outer peripheral surface (outer contour) of an inner ring (4), the inner ring (4) with the outer ring (2) in opposition to an elastic force; and
the clamping element (7) is retained in an activation cage (5) that can be locked by way of an actuatable locking member.

13. A transmission lock according to claim 12, wherein the clamping element (7), in the locked position, is urged via a double ramp (2a) of the outer ring (2) in opposition to an elastic force into a calotte (4a) of an inner ring (4), while the clamping element (7), in the unlocked position, is urged by an elastic force of a locking washer, into a dome of the double ramp (2a) of the outer ring (2), and the clamping element (7) is spaced from the calottes (4a) of the inner ring (4) in the unlocked position.

14. A transmission lock according to claim 12, wherein the activation cage (5) is operatively connected to an activation disc (10), engaging into the accommodation of which is a locking member part (10a) associated with the locking member in a locking position, while it is withdrawn from the accommodation in an unlocked position.

15. A transmission lock according to claim 14, wherein the locking member or the locking member part (10a) associated with the locking member is pivoted essentially in parallel to the course of the longitudinal axis of the activation cage (5).

16. A transmission lock according to claim 14, wherein the locking member includes at least one hinged swivel arm (10), the swivel arm (10) includes at least one engagement part (10a) engaging into the accommodation, at least in part, in order to bring about locking of the transmission.

17. A transmission lock according to claim 16, wherein the accommodation associated with the rotatable transmission element is an axial toothing (6a) interacting with the rotatable transmission element, and that the engagement part includes at least one engaging tooth (10a), which engages into the axial toothing, at least in part, in order to bring about locking of the transmission.

18. A transmission lock according to claim 12, wherein the actuatable locking member can be actuated by way of an electromagnet (9) and locks the transmission in the deenergized condition of the electromagnet (9).

19. A transmission lock according to claim 12, wherein the activation cage (5) is centered between the inner ring (4) and the outer ring (2) by way of an elastic member.

20. A transmission lock according to claim 19, wherein the elastic member centering the activation cage (5) is used to lock the transmission torque-responsively, because in the event of a torque of the transmission which is higher than a biasing moment of the elastic member, the clamping element (7) positively locks the inner ring (4) with the outer ring (2) in opposition to the elastic force by way of the contour of the inner peripheral surface of the outer ring (2) and the contour of the outer peripheral surface of the inner ring (4).

21. A transmission lock according to claim 12, wherein a lock washer (12) is used to generate the elastic force, the lock washer having at least one angled-off portion similar to a torsion spring, which comes into abutment in a groove of the activation cage (5), for the purpose of positioning and avoiding a radial movement of the lock washer (12) in the activation cage (5).

22. A transmission lock according to claim 12, wherein the clamping element (7) is a clamping roller.

23. A superposition steering system comprising:
a superposition transmission with a first input for actuation by a driver;
a second input for a superposition actuator;
an exit to the steering transmission of the steering system, wherein the superposition transmission adjusts an output angle which is used to adjust a wheel angle of a steerable vehicle wheels; and
a locking unit having a clamping element having an inner ring and an outer ring, wherein the clamping element is used to positively lock, by way of a contour of an inner peripheral surface (inner contour) of an outer ring (2) and a contour of an outer peripheral surface (outer contour) of an inner ring (4), the inner ring (4) with the outer ring (2) in opposition to an elastic force, the clamping element (7) is retained in an activation cage (5) that can be locked by way of an actuatable locking member, wherein the locking unit, based on the second input for the superposition actuator, is locked in an event of system failure, and steerability of the vehicle by the driver is maintained.
